(19) United States
(12) Patent Application Publication
(10) Pub. No.: US 2020/0348516 A1
(43) Pub. Date: Nov. 5, 2020

(54) DISPLAY SYSTEM AND DISPLAY METHOD

(71) Applicant: Mitsubishi Electric Corporation, Tokyo (JP)

(72) Inventors: Reiko SAKATA, Tokyo (JP); Naoki FURUHATA, Tokyo (JP); Masami AIKAWA, Tokyo (JP)

(73) Assignee: Mitsubishi Electric Corporation, Tokyo (JP)

(21) Appl. No.: 16/929,940

(22) Filed: Jul. 15, 2020

Related U.S. Application Data
(63) Continuation of application No. PCT/JP2018/004674, filed on Feb. 9, 2018.

(51) Int. Cl. G02B 27/01; G01C 21/00

(52) U.S. Cl. CPC G02B 27/0101; G02B 2027/014; G01C 21/3826

(57) ABSTRACT

A display system includes a first display device and a second display device. The first display device is a display device for a variable object, and displays the variable object in a predetermined area. The second display device is a display device for an invariable object, and displays the invariable object in the predetermined area.

### CROSS REFERENCE TO RELATED APPLICATIONS

This application is a Continuation of PCT International Application No. PCT/JP2018/004674, filed on Feb. 9, 2018, which is hereby expressly incorporated by reference into the present application.

### TECHNICAL FIELD

The present invention relates to a display system.

### BACKGROUND ART

In various scenes such as guidance to a destination, a display device that displays information is used. For example, Patent Literature 1 discloses an image projection device that projects an image of speed information on a windshield of a vehicle by using a first projection unit and projects an image of a traveling direction on the windshield by using a second projection unit. According to the image projection device described in Patent Literature 1, a driver can be notified of a speed by looking at the image of the speed information, and the driver can be notified of a traveling direction by looking at the image of the traveling direction.

### CITATION LIST

### Patent Literatures

Patent Literature 1: JP 2017-122895 A

### SUMMARY OF INVENTION

### Technical Problem

As information to be displayed, information in which both an object having a variable shape (hereinafter, referred to as a “variable object”) and an object having an invariable shape (hereinafter, referred to as an “invariable object”) are combined with each other may be used. In this case, in order to perform display of both the variable object and the invariable object, conventionally, a display device that can change the shape of an object and display the object (hereinafter, referred to as a “variable display device”) has been used.

As described above, by using the variable display device, for example, one display device can display both a variable object and an invariable object. However, in order to display both the objects using one variable display device, a display area of the variable display device needs to be wider than a display area in a case where only one of the objects is displayed, and a wider display area reduces light use efficiency disadvantageously. That is to say, for example, an area unnecessary for displaying an object, such as an area between a variable object and an invariable object, is present in a display area, and therefore light use efficiency is reduced.

For example, a conventional display device such as the image projection device described in Patent Literature 1 does not consider light use efficiency in a case where both a variable object and an invariable object are displayed.

The present invention has been achieved in order to solve the above problem, and an object of the present invention is to obtain a display system that can increase light use efficiency when a variable object and an invariable object are displayed as compared with a case where both the objects are displayed by one display device.

### Solution to Problem

A display system according to the present invention is characterized by including a first display device to make display of an object having a variable shape possible and to display the object having a variable shape on one predetermined surface, and a second display device to make display of an object having an invariable shape possible and to display the object having an invariable shape on the surface, the object having an invariable shape being composed of one or more graphics.

### Advantageous Effects of Invention

According to the present invention, since the first display device that displays an object having a variable shape and the second display device that displays an object having an invariable shape are included, a display device for an object having a variable shape and a display device for an object having an invariable shape can be adopted independently of each other. Thus, light use efficiency can be increased.

### BRIEF DESCRIPTION OF DRAWINGS

FIG. 1 is a diagram illustrating a configuration of a display system according to a first embodiment.

FIGS. 2A and 2B are diagrams illustrating an example of information displayed by the display system according to the first embodiment.

FIG. 3 is a diagram schematically illustrating a configuration example of a second display device.

FIGS. 4A and 4B are diagrams illustrating a case where a direction object is displayed by slide animation.

FIG. 5 is a diagram illustrating an example of information displayed in a case where a plurality of the second display devices is provided.

FIGS. 6A and 6B are diagrams illustrating an example of information displayed by a display system according to a second embodiment.

FIG. 7 is a diagram illustrating another example of the information displayed by the display system according to the second embodiment.

FIGS. 8A and 8B are diagrams illustrating an example of information displayed by a display system according to a third embodiment.

FIG. 9A and FIG. 9B are diagrams each illustrating another example of the information displayed by the display system according to the third embodiment.

FIG. 10 is a diagram illustrating another example of the information displayed by the display system according to the third embodiment.

FIGS. 11A and 11B are diagrams illustrating another example of the information displayed by the display system according to the third embodiment.

### DESCRIPTION OF EMBODIMENTS

Hereinafter, in order to describe the present invention in more detail, embodiments for carrying out the present invention will be described with reference to the attached drawings.

### First Embodiment

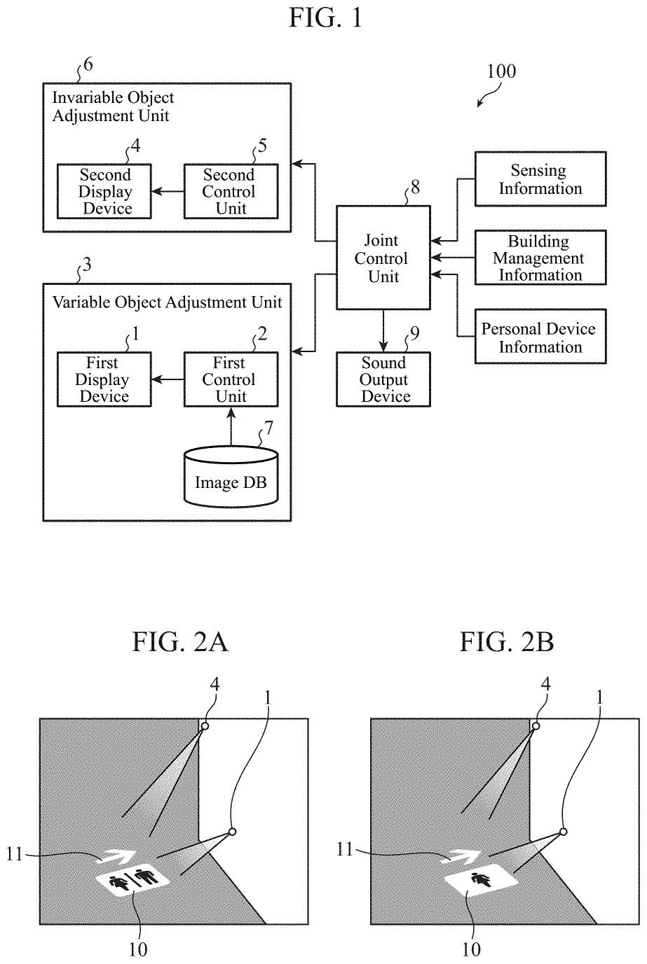

FIG. 1 is a diagram illustrating a configuration of a display system 100 according to a first embodiment.

The display system 100 includes: a variable object adjustment unit 3 including a first display device 1, a first control unit 2, and an image database (DB) 7; an invariable object adjustment unit 6 including a second display device 4 and a second control unit 5; a joint control unit 8; and a sound output device 9.

The first display device 1 is a projection device having a function of displaying an object having a variable shape (hereinafter, referred to as a “variable object”) in a predetermined area. The second display device 4 is a projection device having a function of displaying an object having an invariable shape (hereinafter, referred to as an “invariable object”) in the predetermined area.

The object is information viewed by a person, and is information represented by one or more characters, graphics, symbols, or the likes.

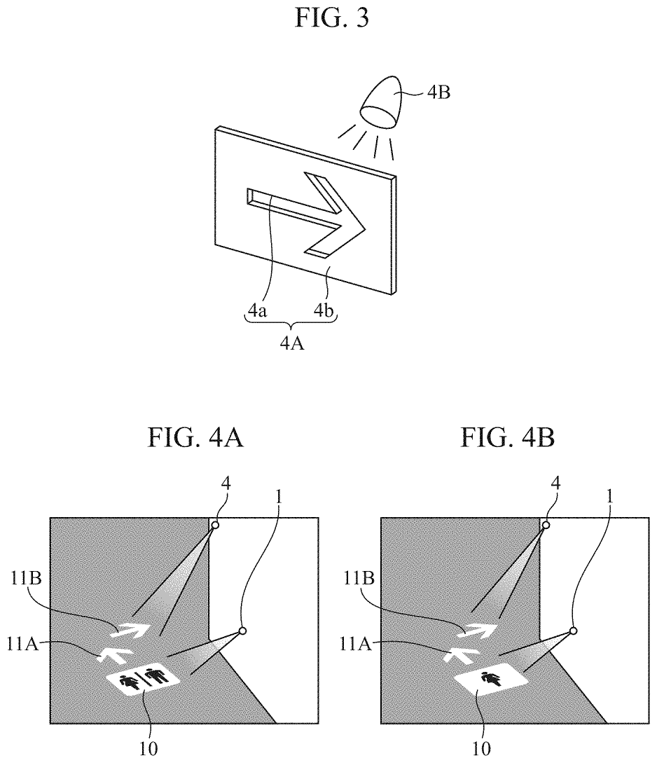

Hereinafter, a case where the first display device 1 and the second display device 4 display objects in a predetermined area by projecting light on the area will be described as an example. In this case, the first display device 1 is, for example, a projector that displays an image on a projection destination by projecting light, such as a cathode ray tube (CRT) projector and a liquid crystal display projector. Hereinafter, description will be made by assuming that the first display device 1 is a liquid crystal display projector. The second display device 4 is, for example, a device including a shade having an opening portion and a light source that emits light and transmits the light through an opening defined by the opening portion of the shade. The shade is used for transmitting only a part of light from the light source, and is made of a light shielding material. The shade may have an appropriate shape such as a plate shape or a box shape. Examples of the shade and the light source will be described later with reference to FIG. 3.

As described above, the first display device 1 and the second display device 4 adopt display methods different from each other. The first display device 1 has a mechanism that displays an object as an image and can change the shape of the object, such as a CRT and a liquid crystal. Meanwhile, the second display device 4 has a mechanism that supplies an electric signal for switching between light emission and non-light emission of a light source to the light source, and allows a person to visually recognize light from a partially light-shielded light source or only light from some light sources that have emitted light among a plurality of light sources.

The first control unit 2 receives a joint control signal from the joint control unit 8 and thereby controls the first display device 1. Specifically, the first control unit 2 outputs a control signal for controlling start of projection, end of projection, the position of a variable object in the predetermined area, the shape of the variable object, or the like to the first display device 1. The image DB 7 stores a plurality of pieces of image data. The first control unit 2 selects image data from the image DB 7 in accordance with a joint control signal from the joint control unit 8, outputs a control signal, and thereby causes the first display device 1 to display an image indicated by the selected image data as a variable object.

The second control unit 5 receives a joint control signal from the joint control unit 8 and thereby controls the second display device 4. Specifically, the second control unit 5 outputs a control signal for controlling start of projection, end of projection, the orientation of an invariable object in the predetermined area, an animation method of the invariable object, the position of the invariable object in the predetermined area, or the like to the second display device 4. Examples of the animation method of the invariable object include blinking of the invariable object, sliding the invariable object, and illuminating parts of the invariable object in order.

The joint control unit 8 acquires sensing information, building management information, and personal device information, and outputs joint control signals to the variable object adjustment unit 3 and the invariable object adjustment unit 6 in accordance with the information. The joint control signal is a signal designating start of projection, end of projection, the position of an object in the predetermined area, image data to be selected from the image DB 7, the orientation of the object in the predetermined area, an animation method of the object, or the like. The joint control unit 8 has information on the positions of various devices installed in a building including the display system 100, the spatial structure of the building, and the like.

The sensing information is output from a monitoring camera, a radar, a lidar, or the like installed in the building including the display system 100. The sensing information indicates a detection result of a pedestrian or a moving object such as a vehicle. For example, the position and moving direction of a detected pedestrian or moving object are indicated in the detection result. Using the sensing information, the joint control unit 8 determines, for example, to cause the first display device 1 and the second display device 4 around the detected pedestrian or moving object to start projection.

The building management information is output from a building management system introduced into the building including the display system 100. The building management information indicates an operating status of an elevator, an escalator, a lavatory, a door, or the like in the building, the number of pedestrians on a passage, or the like.

The personal device information is acquired by wireless communication between the joint control unit 8 and a personal device such as a smartphone. The personal device information indicates the attribute of a person possessing the personal device stored in the personal device, the position of the personal device recognized by the personal device, or the like.

Note that the joint control unit 8 may control the first display device 1 and the second display device 4 using a plurality of pieces of information among the sensing information, the building management information, and the personal device information, or may control the first display device 1 and the second display device 4 using only one of the three pieces of information.

The first control unit 2, the second control unit 5, and the joint control unit 8 are implemented by dedicated hardware or a processor that executes a program stored in a memory, such as a central processing unit (CPU).

FIGS. 2A and 2B are diagrams illustrating an example of information displayed by the display system 100 according to the first embodiment. The information illustrated in FIGS. 2A and 2B notifies a person who views the information of one meaning of guidance to a destination by indicating the destination and the direction of the destination. In each of FIGS. 2A and 2B, a destination object 10 indicating a destination and a direction object 11 indicating the direction of the destination are displayed. Examples of the destination indicated by the destination object include equipment and facilities installed in the building including the display system 100, such as a lavatory and an elevator. In FIGS. 2A and 2B, a case where the destination indicated by the destination object is a lavatory is illustrated as an example.

In FIGS. 2A and 2B, the display system 100 sets a floor surface at a corner of a corridor as a predetermined area on which light for displaying the destination object 10 and the direction object 11 is projected. By projecting light for displaying the destination object 10 and the direction object 11 on a predetermined area, both the objects are caused to be spatially adjacent to each other.

The first display device 1 and the second display device 4 are provided on a wall surface at the corner of the corridor.

The destination object 10 is a variable object that changes the shape thereof depending on the state of a destination, and is displayed by projection of light by the first display device 1. For example, when both a male lavatory and a female lavatory are available, the destination object 10 is an object having a shape indicating the male lavatory and the female lavatory, illustrated in FIG. 2A. Meanwhile, when only a female lavatory becomes available, the destination object 10 changes the shape thereof to an object having a shape indicating only the female lavatory, illustrated in FIG. 2B.

Note that whether or not each of the lavatories is available can be determined by the joint control unit 8, for example, by setting an operating status of each of the lavatories indicated by the building management information or a cleaning schedule of each of the lavatories in the joint control unit 8 in advance. The joint control unit 8 determines image data to be selected from the image DB 7 by the first control unit 2 depending on a result of the determination.

Another example of the destination object is a destination object in a case where a person is guided to an entrance/exit gate. In this case, the shape of the destination object changes, for example, between hours during which the gate is an entrance-only gate and hours during which the gate is an exit-only gate.

The destination object 10 is a variable object and displayed by the first display device 1, whereas the direction object 11 is an invariable object and displayed by the second display device 4.

FIG. 3 is a diagram schematically illustrating a configuration example of the second display device 4. An opening portion 4a is formed in a shade 4A of the second display device 4. The opening portion 4a defines an opening for projecting light for displaying the direction object 11 which is an invariable object on a predetermined area. A portion of the shade 4A other than the opening portion 4a is a light shielding member 4b. A light source 4B of the second display device 4 is provided at a position, the light from the light source 4B at the position passing through the opening defined by the opening portion 4a. With regard to the invariable object, “shape is invariable” means that the shape of this opening is invariable. Therefore, the shape of the invariable object displayed on the predetermined area can change depending on a positional relationship between the predetermined area and the second display device 4, and the like.

The first display device 1 only needs to set at least the region of the destination object 10 in information displayed by the display system 100 as a projection region. The second display device 4 only needs to set at least the region of the direction object 11 in the information displayed by the display system 100 as a projection region. That is to say, neither the first display device 1 nor the second display device 4 needs to disperse and project light over a wide region including both the destination object 10 and the direction object 11.

Since the destination object 10 is displayed by projection of light by the first display device 1, and the direction object 11 is displayed by projection of light by the second display device 4, the information can be displayed in a state where an area between the adjacent destination object 10 and direction object 11 is not included in a projection region.

Since the first display device 1 and the second display device 4 are display devices independent of each other, regardless of a projection method adopted by the first display device 1, a projection method adopted by the second display device 4 can be determined. Projection using the shade 4A and the light source 4B can allow light from the light source 4B to reach a predetermined area as it is, and therefore has higher light use efficiency than projection by a liquid crystal display projector that causes light from a light source to finally reach a predetermined area while causing the light to pass through a liquid crystal panel.

In a case where, unlike the display system 100, both a variable object and an invariable object are collectively displayed by one display device, for example, by one liquid crystal display projector, a projection region of the one display device is wide, and therefore the one display device needs to disperse light widely. In a case where light is widely dispersed, light use efficiency is reduced.

In addition, as described above, in a case where both the objects are collectively displayed by one display device, an area between the adjacent variable object and invariable object, the area being an area other than the objects, is also included in a projection region. Since an area other than the objects is included in the projection region, light use efficiency in displaying information is reduced.

In addition, in a case where one display device that displays both the objects by projection is a liquid crystal display projector, not only the variable object but also the invariable object is displayed by a liquid crystal display projector having low light use efficiency.

Therefore, the display system 100 including the first display device 1 for the destination object 10 and including the second display device 4 for the direction object 11 can increase light use efficiency as compared with the case where both the destination object 10 and the direction object 11 are displayed by one display device, for example, by one liquid crystal display projector. An increase in light use efficiency leads to energy saving.

As illustrated in FIGS. 2A and 2B, the first display device 1 and the second display device 4 are independent of each other, and therefore can be provided at different places. For example, the first display device 1 that is a liquid crystal display projector is a display device that can change the shape of an object, and therefore has a complicated structure. Thus, the first display device 1 has a short life. Meanwhile, for example, the second display device 4 including the shade 4A and the light source 4B is a display device that does not need to change the shape of an object, and therefore has a simple structure. Thus, the second display device 4 has a long life. Therefore, in a case where information is displayed near a structure which is difficult to replace, such as an elevator and an escalator, the first display device 1 is preferably provided outside the structure, and the second display device 4 is preferably incorporated in the structure. This makes it possible to suppress the number of devices additionally provided outside a structure, and also to suppress an influence on the life of a structure which is difficult to replace, such as an elevator and an escalator. When the first display device 1 having a short life is incorporated in a structure which is difficult to replace, such as an elevator and an escalator, the entire structure may be replaced when the first display device 1 is broken, and thus the life of the structure is reduced.

In addition, in terms of ensuring sufficient brightness of an object and ensuring diversity of expression of the object, a distance between a predetermined area where the object is displayed and the second display device 4 is preferably longer than a distance between the area and the first display device 1. In FIGS. 2A and 2B, by providing the first display device 1 at a low position on a wall surface and providing the second display device 4 at a high position on the wall surface, a distance between a predetermined area on a floor surface and the second display device 4 is longer than a distance between the area and the first display device 1.

By reducing a distance between the first display device 1 and a floor surface on which the destination object 10 is displayed, the brightness of the destination object 10 can be increased even when the first display device 1 is a liquid crystal display projector, and thus light use efficiency is increased.

Meanwhile, by increasing a distance between the second display device 4 and a floor surface on which the direction object 11 is displayed, a slide interval during slide animation can be increased, or the direction object 11 can be displayed largely. Note that projection by the second display device 4 using the shade 4A and the light source 4B can allow light from the light source 4B to reach a predetermined area as it is, and therefore sufficient brightness of the direction object 11 is ensured even when the second display device 4 is far from a floor surface.

FIGS. 4A and 4B illustrate a case where the direction object 11 is displayed by slide animation in order to more clearly illustrate the direction of a destination. In the slide animation, a direction object 11A is first displayed as the direction object 11. Thereafter, light emission of the light source 4B is temporarily interrupted, the shade 4A is moved by a moving mechanism (not illustrated) controlled by the second control unit 5, then the light source 4B emits light again, and a direction object 11B is thereby displayed instead of the direction object 11A. Furthermore, thereafter, light emission of the light source 4B is temporarily interrupted, the shade 4A is moved by the moving mechanism, then the light source 4B emits light again, and the direction object 11A is thereby displayed instead of the direction object 11B. By repeating these procedures, the direction object 11A and the direction object 11B indicating different directions are alternately illuminated. Note that FIGS. 4A and 4B illustrate both the direction object 11A and the direction object 11B at the same time for convenience.

In addition, by moving the shade 4A by using a moving mechanism (not illustrated) controlled by the second control unit 5 while light emission of the light source 4B is maintained, the direction object 11 can be displayed on a floor surface in such a way that the direction object 11 slides while drawing a winding track. Such display of the direction object 11 is useful in a case where a corridor leading to a destination is winding, in a case where it is desired to indicate a detailed route to the destination, and the like. Note that when the second display device 4 is provided at a position where the second display device 4 can project light onto a predetermined area from directly above to display the direction object 11, the second display device 4 easily slides the direction object 11 in a track as intended.

When the direction object 11 is displayed by the slide animation illustrated in FIGS. 4A and 4B or in such a way that the direction object 11 slides while drawing a winding track as described above, a viewer of the direction object 11 may recognize that the shape of the direction object 11 has changed. However, this is caused by, for example, a change in the positional relationship between the predetermined area and the second display device 4 as described above. The original shape before a person views as displayed information, that is, the shape of light at the time of passing through the opening defined by the opening portion 4a in the configuration example of the second display device 4 illustrated in FIG. 3 is invariable all the time.

Note that a plurality of the second display devices 4 may be provided. As a result, one destination object 10 and a plurality of direction objects 11 can constitute information.

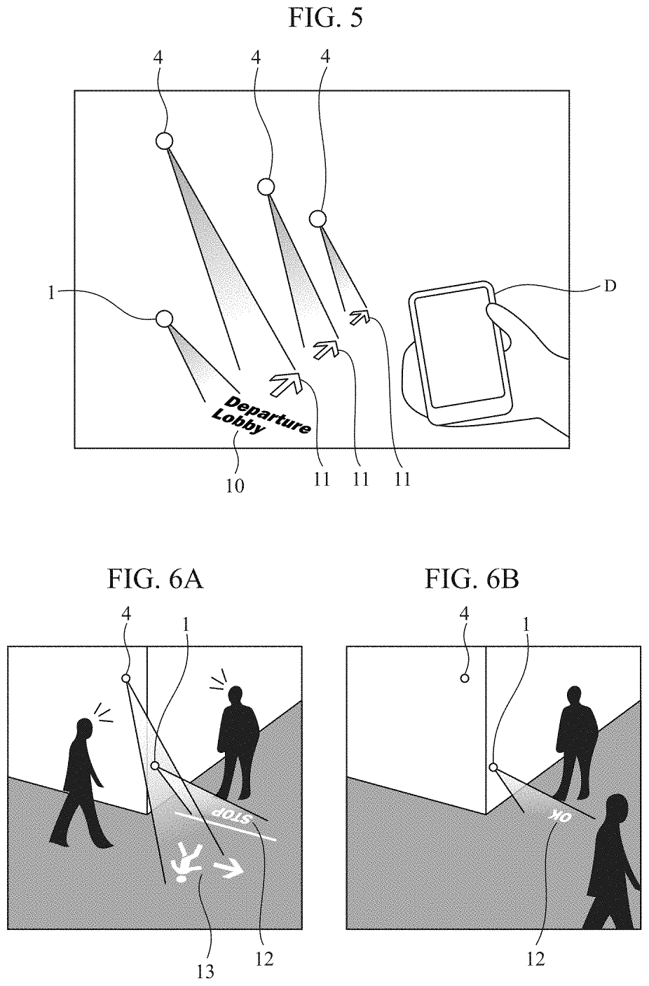

FIG. 5 is an example of information displayed in a case where a plurality of the second display devices 4 is provided. The plurality of direction objects 11 may be displayed by projection of light at the same time or may be displayed by projection of light in order. Even the plurality of direction objects 11 can be displayed, by adjusting timings of projection thereof, as an object indicating the direction of the destination indicated by one destination object 10.

In a case where it is intended to smoothly guide a flow of persons with the displayed information, the direction objects 11 are preferably displayed in order in a direction in which the flow is desired to be guided. In addition, on the basis of personal device information that the joint control unit 8 acquires from a personal device D, at a timing when it is detected that a person possessing the personal device D has approached the first display device 1 and the second display devices 4, information indicating the direction of a destination to which the person wants to go may be displayed. The information is particularly useful as information for guidance in a large space.

Note that in the above description, the case where the first display device 1 and the second display device 4 project light and thereby display objects has been described as an example, but both or either of the first display device 1 and the second display device 4 themselves may include a display screen directly viewed by a person, and the object may be displayed on the display screen. In a case where the first display device 1 displays an object on a display screen directly viewed by a person, the first display device 1 is, for example, a liquid crystal display. In a case where the second display device 4 displays an object on a display screen directly viewed by a person, the second display device 4 uses, for example, a device including, in a similar manner to that illustrated in FIG. 3, a light source and a shade including an opening portion that defines an opening that transmits light of the light source as a display screen, or uses a plurality of light sources arranged in an array as a display screen. In the case where an object is displayed on a display screen directly viewed by a person, the first display device 1 and the second display device 4 are embedded, for example, in a floor surface at a corner of a corridor, and display the destination object 10 and the direction object 11 as illustrated in FIGS. 2A and 2B.

In the above description, the display system 100 includes the joint control unit 8, but by setting information in which start of projection, end of projection, a position where light for displaying an object is projected, image data to be selected from the image DB 7, the orientation of the object in a predetermined area, an animation method of the object, and the like are designated for each hour in the first control unit 2 and the second control unit 5 in advance, the display system 100 may be constituted without the joint control unit 8.

In the above description, the display system 100 includes the image DB 7, but the first control unit 2 may create image data for the destination object 10 to be displayed each time, and the display system 100 may be thereby constituted without the image DB 7.

In the above description, the case where the plurality of second display devices 4 is provided, and thereby the plurality of direction objects 11 indicates the direction of one destination has been described with reference to FIG. 5. Similarly, a plurality of the first display devices 1 may be provided, and thereby a plurality of the destination objects 10 may indicate one or more destinations.

The display system 100 may be included not only in a building but also in various structures such as a telegraph pole, a traffic light, and a fence beside a sidewalk, and thereby may display information for a person walking on the sidewalk.

The display system 100 may include the sound output device 9, as illustrated in FIG. 1. The sound output device 9 is a speaker that is controlled by the joint control unit 8 and outputs a sound such as a chime or a melody. Note that the sound output device 9 may output guidance voice using a language, such as an announcement. Since the sound output device 9 outputs a sound, understandability of information displayed by the display system 100 is improved. In short, the sound output device 9 outputs a sound related to a variable object or an invariable object as described below.

For example, the sound output device 9 outputs a sound that is heard in a wider region than a predetermined area in which a variable object and an invariable object are displayed, and thereby urges a person to pay attention to the information displayed by the display system 100. As described above, the sound output device 9 outputs a sound, and a person who does not view information can be thereby notified of presence of the information.

For example, the sound output device 9 outputs sounds that are heard as if the sounds were being produced at the positions of respective objects displayed in a predetermined area. In this case, by outputting a sound in such a manner that the position of an object recognized to be a position where a sound is being produced moves, or by outputting a sound in such a manner that it is recognized that a sound is being produced only at the position of a specific object, the sound output device 9 notifies a person of the order in which the person should view the objects. For example, description will be made with reference to FIG. 5. By outputting a sound in such a manner that the position of the direction object 11 recognized to be a position where a sound is being produced moves according to the order in which the direction objects 11 are displayed, the sound output device 9 emphasizes the direction of a destination. As described above, the sound output device 9 outputs a sound, and the meaning of information can be thereby complemented. Such sound output is particularly useful in a case where a predetermined area where a variable object and an invariable object are displayed is wide.

The first display device 1 and the second display device 4 may be constituted as one device. In this case, the one device corresponds to the display system 100. One device including the first display device 1 and the second display device 4 is attached to, for example, a wall surface at a corner of a corridor, and displays information as illustrated in FIG. 2A or 2B.

As described above, according to the first embodiment, the display system 100 includes the first display device 1 that displays a variable object and the second display device 4 that displays an invariable object. A display device for a variable object and a display device for an invariable object can be adopted independently of each other, and thus light use efficiency can be increased. In addition, each of the variable object and the invariable object can be displayed in an optimal state, and thus visibility of information is ensured.

The first display device 1 projects light on a predetermined area and thereby displays an object having a variable shape in the area, and the second display device 4 projects light on the predetermined area and thereby displays an object having an invariable shape in the area. Since the first display device 1 and the second display device 4 can each display an object at various positions by changing a projection angle, the first display device 1 and the second display device 4 can each provide flexibility to the position of the object as compared with a case where the object is displayed on a display screen directly viewed by a person.

The first display device 1 is a projector, and the second display device 4 includes the shade 4A having the opening portion 4a that defines the opening for projecting light on the predetermined area, and the light source 4B that allows light to pass through the opening. The projector can easily change the shape of an object, and the device including the shade 4A and the light source 4B that allows light to pass through the opening defined by the opening portion 4a of the shade 4A can display an object having an invariable shape by using a simple structure.

A distance between the second display device 4 and the predetermined area is longer than a distance between the first display device 1 and the predetermined area. This makes it possible to increase the brightness of an object having a variable shape, the object being displayed by projection of light by the first display device 1. In addition, this makes it easy to ensure diversity of expressions of an object having an invariable shape, the object being displayed by projection of light by the second display device 4.

The object having a variable shape is the destination object 10 indicating a destination, and the object having an invariable shape is the direction object 11 indicating the direction of the destination. As described above, the display system 100 can notify a person who views information of one meaning of guidance to a destination.

In addition, the display system 100 includes the joint control unit 8 that controls the first display device 1 and the second display device 4 using sensing information indicating a detection result of an object, building management information indicating a state of a building including the first display device 1 and the second display device 4, or personal device information indicating information on a person or a personal device possessed by the person. As a result, the display system 100 can display information linked to sensing information, building management information, or personal device information.

In addition, the display system 100 includes the sound output device 9 that outputs a sound related to an object having a variable shape or an object having an invariable shape. As a result, understandability of information displayed by the display system 100 can be improved.

### Second Embodiment

In a second embodiment, a case will be described in which a display system 100 displays a different type of information from the first embodiment. As described in the first embodiment, a first display device 1 and a second display device 4 may each display an object by projecting light, or may each display an object on a display screen directly viewed by a person.

FIG. 1 is referred to for a configuration of the display system 100 according to the second embodiment.

FIGS. 6A and 6B are diagrams illustrating an example of information displayed by the display system 100 according to the second embodiment. The information illustrated in FIGS. 6A and 6B notifies a person who views the information of one meaning of alerting by indicating, for the person, an action that the person should take together with presence of an object to which attention should be paid. In FIGS. 6A and 6B, a regulation object 12 and an attention object 13 are displayed. The regulation object 12 regulates an action of a person who views the object. The attention object 13 urges a person who views the object to pay attention.

The regulation object 12 is a variable object that changes the shape thereof depending on an action to be taken by a person, and is displayed by the first display device 1. The regulation object 12 is, for example, a character object such as “STOP”, “GO”, or “OK”. As illustrated in FIG. 6A, the regulation object 12 may indicate the position where a person should stop, with a line. The regulation object 12 notifies a person of a specific action to be taken by the person.

The regulation object 12 is a variable object and displayed by the first display device 1, whereas the attention object 13 is an invariable object and displayed by the second display device 4. The attention object 13 notifies a person as a target for alerting of presence of an object to which attention should be paid by rotating the orientation of the attention object 13 depending on the direction in which the person is present. The attention object 13 may be indicated by an appropriate animation such as blinking.

In FIGS. 6A and 6B, a floor surface at a corner of a corridor is a predetermined area where the regulation object 12 and the attention object 13 are displayed. As described above, the regulation object 12 and the attention object 13 are displayed at a place where a person may come out of an invisible position, such as a corner of a corridor, the front of a door, and an elevator entrance, and a contact accident between a person and a person can be thereby prevented.

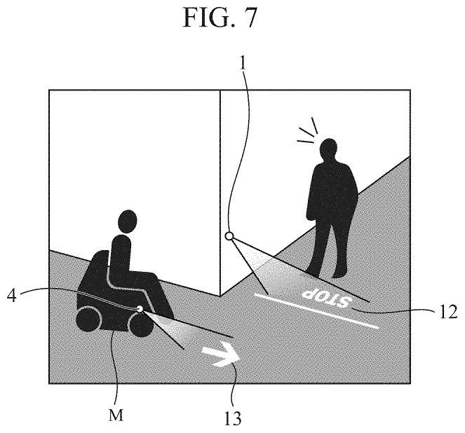

FIG. 7 is a diagram illustrating another example of the information displayed by the display system 100 according to the second embodiment. In FIG. 7, the second display device 4 is mounted on a moving object M. The second display device 4 is a simple device having, for example, the light source 4B and the shade 4A as described in the first embodiment. Therefore, even in a case where the second display device 4 is mounted on the moving object M, an increase in the mass of the entire moving object M and an increase in power consumption of the moving object M can be suppressed. The moving object M is a robot that autonomously travels in a building including the display system 100, a vehicle that travels with a person mounted thereon in the building, or the like.

As illustrated in FIG. 7, the regulation object 12 and the attention object 13 are displayed at a place where the moving object M may come out of an invisible position, such as a corner of a corridor, the front of a door, and an elevator entrance, and a contact accident between a person and the moving object M can be thereby prevented.

Note that both the regulation object 12 and the attention object 13 are preferably displayed at timings close to each other by causing a time difference between display of the regulation object 12 by the first display device 1 and display of the attention object 13 by the second display device 4 to be within a predetermined time. By performing projection by the first display device 1 and projection by the second display device 4 at a timing when the moving object M approaches a corner of a corridor, the front of a door, an elevator entrance, or the like, information for a person at the corner of the corridor, the front of the door, the elevator entrance, or the like is displayed. In a case where information by the display system 100 is displayed all the time, a person does not notice the information in some cases. By display of information by the display system 100 only when the moving object M approaches a corner of a corridor, the front of a door, an elevator entrance, or the like, a person easily notices the information and thus can be notified of alerting more effectively. The same applies to cases other than FIG. 7; by displaying a variable object and an invariable object at timings close to each other, information is easily noticed by a person.

As in the first embodiment, a sound output device 9 may output a sound in such a manner as to notify a person who does not view information of presence of the information, or may output a sound in such a manner as to complement the meaning of the information. For example, the case where the meaning is complemented will be described with reference to FIG. 7. The sound output device 9 outputs a sound that easily attracts a person's attention so that it is recognized that the sound is being produced at the position of the attention object 13, and thereby emphasizes contents to which attention should be paid.

As described above, according to the second embodiment, effects similar to the first embodiment can be obtained.

The object having a variable shape is the regulation object 12 that regulates an action of a person, the object having an invariable shape is the attention object 13 that urges the person to pay attention, and therefore a person who views information can be notified of one meaning of alerting.

A time difference between display by the first display device 1 and display by the second display device 4 is within a predetermined time. Therefore, information is easily noticed by a person. In addition, the contents of alerting indicated by the information are easily understood by a person who views the information, and thus the person who views the information can take an action to avoid a contact accident or the like after understanding the situation.

### Third Embodiment

In a third embodiment, a case will be described in which a display system 100 displays a different type of information from the first and second embodiments. As described in the first embodiment, a first display device 1 and a second display device 4 may each display an object by projecting light, or may each display an object on a display screen directly viewed by a person.

FIG. 1 is referred to for a configuration of the display system 100 according to the third embodiment.

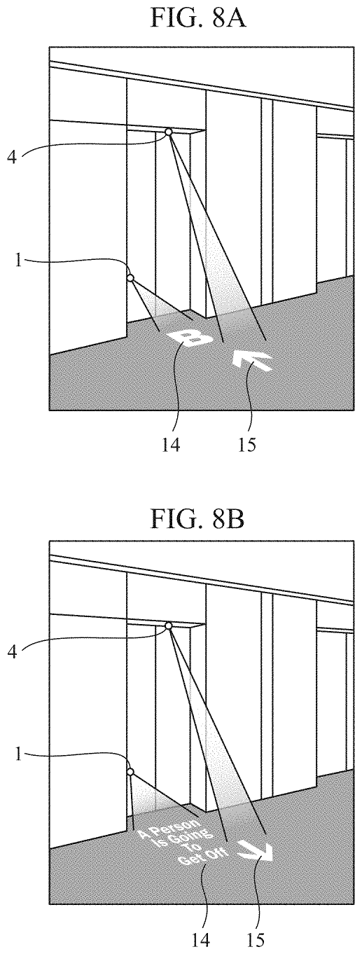

Information displayed by the display system 100 according to the third embodiment notifies a person who views the information of one meaning of usage by indicating the attribute of the person or information on a facility together with a recommended action. As the information displayed, as illustrated in FIGS. 8A and 8B, a person or facility object 14 and an action object 15 are displayed. The person or facility object 14 indicates the attribute of a person or information on a facility to be used by the person. The action object 15 urges the person to take an action.

The person or facility object 14 is a variable object that changes the shape thereof depending on: an operating status of an elevator, an escalator, a lavatory, a door, or the like; the number of pedestrians on a passage; the attributes of the pedestrians; or the like, and is displayed by the first display device 1.

The person or facility object 14 is a variable object and displayed by the first display device 1, whereas the action object 15 is an invariable object and displayed by the second display device 4. The action object 15 may change the position thereof or rotate the orientation thereof depending on: an operating status of an elevator, an escalator, a lavatory, a door, or the like; the number of pedestrians on a passage; the attributes of the pedestrians; or the like. The action object 15 may be indicated by an appropriate animation such as blinking.

FIGS. 8A and 8B are diagrams illustrating an example of information displayed by the display system 100 according to the third embodiment. In FIGS. 8A and 8B, a floor surface in front of an elevator is a predetermined area where the person or facility object 14 and the action object 15 are displayed. As illustrated in FIG. 8A, the display system 100 guides a person to use an elevator B by displaying the person or facility object 14 and the action object 15 in a case where a door of the elevator B is about to open.

In a case where the operating status of the elevator changes due to, for example, a press of a floor button inside a car of the elevator B, and a person is going to get off the elevator B, as illustrated in FIG. 8B, the person or facility object 14 changes to a shape of “a person is going to get off”. As a result, information that notifies a person in an elevator hall of using the elevator while paying attention to a person getting off is displayed. As described above, the shape of the person or facility object 14 changes depending on the state of a person at an invisible position, that is, inside the car of the elevator, such as a state where a floor button is pressed and thereby a floor for getting off is designated.

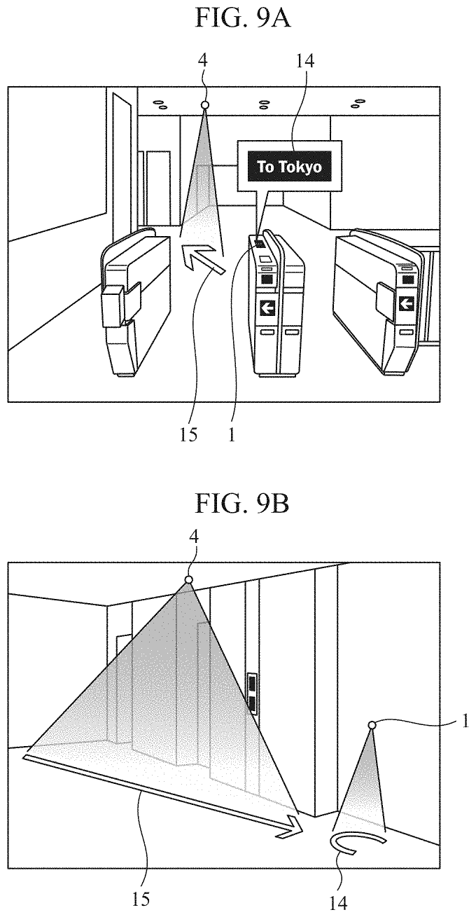

FIGS. 9A and 9B are diagrams each illustrating another example of the information displayed by the display system 100 according to the third embodiment. The person or facility object 14 indicates a train or an elevator to be used by a person who views the information. The action object 15 indicates a direction in which the person who views the information should go.

FIG. 9A illustrates an application example of the display system 100 in a ticket gate of a station, and an area around an automatic ticket gate is a predetermined area where the person or facility object 14 and the action object 15 are displayed. The first display device 1 is a liquid crystal display, and is provided in the automatic ticket gate. When a person passes through the automatic ticket gate, for example, the person or facility object 14 of “to Tokyo” is displayed on the first display device 1 provided in the automatic ticket gate. The second display device 4 displays the action object 15 on a floor or the like around the automatic ticket gate. In the example illustrated in FIG. 9A, the action object 15 indicates, for example, the direction of a platform at which a train bound for Tokyo departs. The shape of the person or facility object 14 changes depending on the attribute of a person for whom information is to be displayed. For example, in a case where going to Osaka is obtained as the attribute of the person, the person or facility object 14 of “to Osaka” is displayed on the first display device 1. The action object 15 is an invariable object, but only an indication direction changes depending on the attribute of a person as to where to go.

FIG. 9B illustrates an application example of the display system 100 in an elevator, and a floor surface in front of the elevator is a predetermined area where the person or facility object 14 and the action object 15 are displayed. The person or facility object 14 of “C” is displayed in front of an elevator C. At this time, the action object 15 indicates a direction toward the elevator C. The shape of the person or facility object 14 changes depending on the attribute of a person. For example, in a case where information is displayed for a person whose working office is on the Nth floor, when the elevator C is set so as to operate by skipping the Nth floor, the person or facility object 14 of “A” is displayed, for example, on a floor in front of an elevator A whose stop floors include the Nth floor. In addition, the action object 15 is an invariable object, but only an indication direction changes to a direction toward the elevator A depending on the attribute of the person.

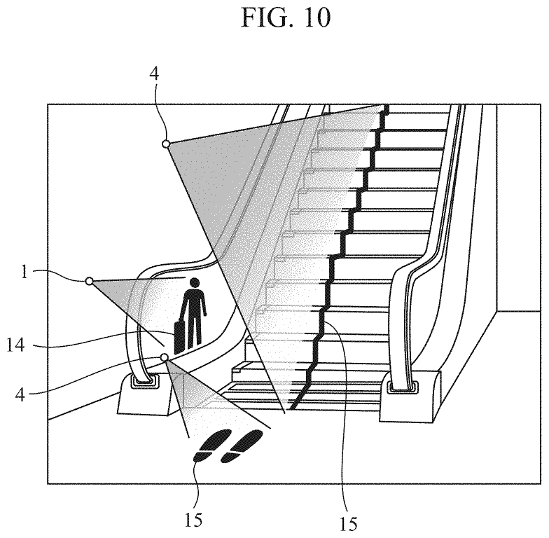

FIG. 10 illustrates another example of the information displayed by the display system 100 according to the third embodiment, and a landing area of an escalator is a predetermined area where the person or facility object 14 and the action object 15 are displayed. The person or facility object 14 is a moving image indicating how to use the escalator. At this time, the action objects 15 indicate the positions of feet recommended for a person who uses the escalator, the width of a passage at escalator steps, and the like. The person or facility object 14 is illustrated while changing the shape thereof as a moving image indicating how to use the escalator. Meanwhile, the action object 15 is an invariable object, and only a display position changes depending on, for example, a congestion condition. For example, when the escalator is not crowded, the position of the action object 15 indicating the positions of feet recommended for a person who uses the escalator is closer to the escalator step than that when the escalator is crowded.

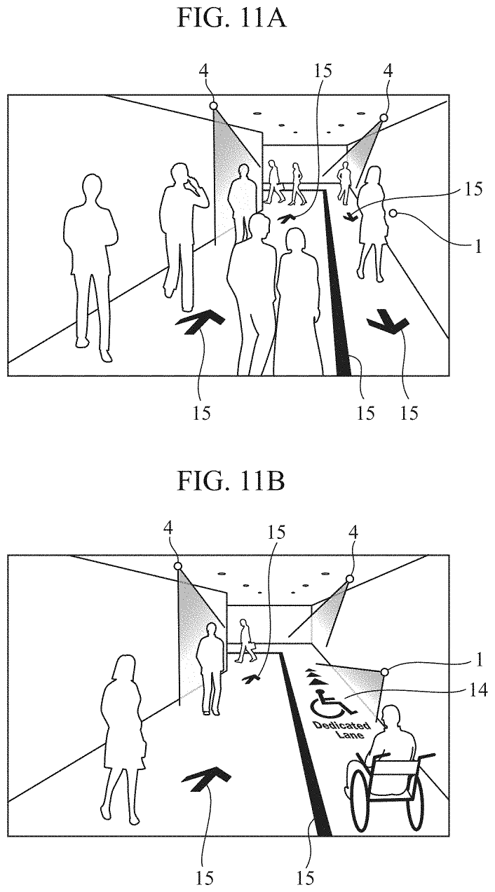

FIGS. 11A and 11B illustrate another example of the information displayed by the display system 100 according to the third embodiment, and a floor surface of a corridor is a predetermined area where the person or facility object 14 and the action object 15 are displayed. The shape of the person or facility object 14 changes depending on hours or a person using a passage. For example, as illustrated in FIGS. 11A and 11B, in a case where there is a wheelchair user, the person or facility object 14 changes to a shape of “wheelchair dedicated lane”. The action objects 15 indicate a center line of a passage, a traveling direction of the passage, and the like. The action object 15 is an invariable object, and only the position thereof, the orientation thereof, or the like changes depending on, for example, hours.

As in the first embodiment, a sound output device 9 may output a sound in such a manner as to notify a person who does not view information of presence of the information, or may output a sound in such a manner as to complement the meaning of the information. For example, the case where the meaning is complemented will be described with reference to FIG. 9A. The sound output device 9 outputs a sound that easily attracts a person's attention so that it is recognized that the sound is being produced, first at the position of the person or facility object 14 and next at the position of the action object 15, and thereby guides the gaze of a person. For example, the case where the meaning is complemented will be described with reference to FIG. 9B. The sound output device 9 outputs a sound that easily attracts a person's attention so that it is recognized that the sound is being produced, first at the position of the action object 15 and next at the position of the person or facility object 14, and thereby guides the gaze of a person.

As described above, according to the third embodiment, effects similar to the first embodiment can be obtained.

The object having a variable shape is the person or facility object 14 that indicates the attribute of a person or information on a facility to be used by the person, the object having an invariable shape is the action object 15 that urges the person to take an action, and therefore a person who views information can be notified of one meaning of usage. Display of the person or facility object 14 that changes the shape thereof depending on an operating status of an elevator, the attribute of a person, or the like, and the action object 15 that urges the person to take an action contributes to improvement of satisfaction when a facility, such as an elevator, is used.

Note that the present invention can freely combine the embodiments with each other, modify any component in each of the embodiments, or omit any component in each of the embodiments within the scope of the invention.

### INDUSTRIAL APPLICABILITY

As described above, the display system according to the present invention can display information with high light use efficiency, and is therefore suitable for use as, for example, a display system for guide to a destination.

### REFERENCE SIGNS LIST

1: first display device, 2: first control unit, 3: variable object adjustment unit, 4: second display device, 4A: shade, 4B: light source, 4a: opening portion, 4b: light shielding member, 5: second control unit, 6: invariable object adjustment unit, 7: image DB, 8: joint control unit, 9: sound output device, 10: destination object, 11, 11A, 11B: direction object, 12: regulation object, 13: attention object, 14: person or facility object, 15: action object, 100: display system

1. A display system comprising:
a first display device to make display of an object having a variable shape possible and to display the object having a variable shape on one predetermined surface; and
a second display device to make display of an object having an invariable shape possible and to display the object having an invariable shape on the surface, the object having an invariable shape being composed of one or more graphics.

2. The display system according to claim 1, wherein
the first display device projects light on the surface, and thereby displays the object having a variable shape on the surface,
the second display device projects light on the surface, and thereby displays the object having an invariable shape on the surface, and
the second display device has a light use efficiency higher than a light use efficiency of the first display device.

3. The display system according to claim 2, wherein
the second display device includes
a light source, and
a shade to allow a part of light from the light source to pass through the shade, the shade including a light shielding member, the light shielding member defining a shape of the object having an invariable shape by having an invariable shape and a light shielding property.

4. The display system according to claim 1, wherein
the first display device is a liquid crystal display projector.

5. The display system according to claim 1, wherein
the first display device has an estimated life shorter than an estimated life of the second display device,
the first display device is provided outside a structure, and
the second display device is incorporated in the structure.

6. The display system according to claim 1, wherein a time difference between display by the first display device and display by the second display device is within a predetermined time.

7. The display system according to claim 2, wherein a distance between the second display device and the surface is longer than a distance between the first display device and the surface.

8. The display system according to claim 1, wherein
the object having a variable shape is a destination object indicating a destination, and
the object having an invariable shape is a direction object indicating a direction of the destination.

9. The display system according to claim 1, wherein
the object having a variable shape is a regulation object for regulating an action of a person, and
the object having an invariable shape is an attention object for urging the person to pay attention.

10. The display system according to claim 1, wherein
the object having a variable shape is a person or facility object indicating an attribute of a person or information on a facility to be used by the person, and
the object having an invariable shape is an action object for urging the person to take an action.

11. The display system according to claim 1, further comprising a controller to control the first display device and the second display device using sensing information indicating a detection result of an object, building management information indicating a state of a building including the first display device and the second display device, or personal device information indicating information on a person or a personal device possessed by the person.

12. The display system according to claim 1, further comprising a speaker to output a sound related to the object having a variable shape or the object having an invariable shape.

13. A display method comprising:
displaying an object having a variable shape on one predetermined surface using a first display device to make display of the object having a variable shape possible; and
displaying an object having an invariable shape on the surface using a second display device to make display of the object having an invariable shape possible, the object having an invariable shape being composed of one or more graphics.
